(19) United States
(12) Patent Application Publication
(10) Pub. No.: US 2007/0276301 A1
(43) Pub. Date: Nov. 29, 2007

(54) Massage Arm

(75) Inventor: Uwe Schefthaler, Taufkirchen/Vils (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: OKIN GESELLSCHAFT FUR ANTRIEBSTECHNIK MBH, Gummersbach (DE)

(21) Appl. No.: 10/599,771

(22) PCT Filed: Apr. 7, 2005
(86) PCT No.: PCT/DE05/00617

§ 371 Date: Jul. 30, 2007

(30) Foreign Application Priority Data
Apr. 8, 2004 (DE) 20 2004 005 855.3

(51) Int. Cl. A61H 7/00

(52) U.S. Cl. 601/86

(57) ABSTRACT

A massage arm (1) comprising a massage element (2) for a massage unit which can be mounted on a massage chair or other seat or other item of furniture used for seating or lying purposes, wherein the massage arm (1) is coupled to at least one shaft, which can be displaced in the massage unit by means of a drive in order to produce a first vibrating movement within a first frequency range, and is connected to the massage element (2) in an articulated manner. The massage element (2) has at least one contact surface which acts upon the body of the person receiving the massage. According to the invention, in order to achieve an improved massage effect, a vibration device (8) is provided. Said vibration device produces a second vibrating movement which is superposed on the first, said vibration movement occurring within a higher frequency range in comparison with the first.

The invention relates to a massage arm with a massage element for a massage unit that can be mounted in a massage chair or another item of furniture used for sitting or lying, where the massage arm is coupled to at least one shaft, which can be displaced in the massage unit by means of a drive in order to produce a first vibrating movement in a first frequency range, and is connected to the massage element in articulated fashion.

Various embodiments of massage arms of this kind are known. The massage unit customarily consists of a massage carriage, which can be incorporated into the backrest of a massage chair, or into another item of furniture to be equipped with a massage unit, and can be moved back and forth along a frame by means of a drive. As a rule, the massage carriage displays two motor-driven shafts, via which oscillation of two massage arms, each provided with a massage element, is generated. To this end, each massage arm expediently consists of a holding arm, connected in articulated fashion to the one shaft, on the free end of which the massage element is located, and a projecting arm, connected in articulated fashion to the second shaft, one end of which acts on the holding arm. To generate the oscillation, the ends of both shafts can display eccentric areas, on which the holding arm and the projecting arm are mounted. In this context, the eccentric areas at the ends of the shaft connected to the holding arm can be angled relative to this shaft, such that, when this shaft rotates, the holding arms bearing the massage elements perform a pivoting movement about an essentially horizontal axis extending through the intersection of the shaft in question and the angled axis of the eccentric areas. The massaging action generated by this movement of the massage elements is referred to as “kneading”.

The movement of the shaft connected to the projecting arm is such that, when superimposed on the eccentric oscillation of the shaft connected to the holding arms, essentially vertical movement of the massage elements is generated via the projecting arms, possibly with a component oriented perpendicular to the frame. The massaging action exerted by this movement is also referred to as “tapping”.

Massage arms of this kind are known from WO 97/37627, for example. The techniques of kneading and tapping described above are intended to more or less simulate manual massaging by a masseur.

The object of the present invention is to further improve the massage effect exerted by a massage arm with a massage element on the body of the person to be massaged in the conventional techniques.

According to the invention, the object is solved in that, on a massage arm with a massage element of the kind mentioned above, a vibration device is provided for generating a second vibrating movement, which is superimposed on the first vibrating movement, transmitted to the massage arm by the moving shaft, and displays a higher frequency range than the first vibrating movement.

The second frequency range is preferably in the range between 15 and 100 Hz. The advantage of an additional vibration device, acting directly on the massage arm and/or the massage element, lies in the relaxing, cramp-relieving effect on the muscles of the person to be massaged.

Massage devices with vibration systems are known. They have, for example, the form of mats with several, rigidly fixed vibration units, or they are designed as hand-held units permitting targeted treatment of problem zones. However, these vibration systems are incapable of achieving the massage effect of a therapist, particularly the kneading movement of the muscle. Meridians are poorly activated, and uniform treatment over large areas, e.g. the back of a patient, is not possible.

Open to consideration as vibration devices that act directly on the massage arm and/or the massage element are, for example, electric motors with small dimensions, the drive shaft of which is provided with an unbalance. It is also possible to use coils with metal cores or armatures, which can be set into vibrating motion by means of alternating voltage.

The second vibrating movement, achieved by the vibration device, is preferably in the frequency range from 20 to 70 Hz. The second frequency range is optimally from 20 to 40 Hz.

In a preferred embodiment of the invention, the vibration device, e.g. an electric motor with an unbalance, is rigidly located on the massage element, expediently in the vicinity of the contact surface of the massage element acting on the body of the person to be massaged.

The massage elements open to consideration here usually display at least one massage body, the surface of which forms the surface in contact with the person to be massaged. The vibration device can then be located in the massage body.

In particular, the massage body or bodies can be of dome-shaped design on the side of the massage element facing the body. The vibration device can consequently be installed in one or more of the dome-shaped massage bodies from the opposite side of the massage element.

The massage bodies can also be designed in the form of rollers, as is customary, in which context the vibration device can be installed in the rollers.

The vibration device can also be attached to the massage arm, such that the vibration transmitted to the massage arm is transmitted to the massage element via the articulated connection.

Owing to the higher-frequency vibrating movement generated by the vibration device, the articulated connection between the massage arm and the massage element should be designed to be as flexible as possible. The articulated connection is preferably designed as a ball-and-socket joint.

However, other suitable articulated connections can also be selected that enable rotary movement of the massage element relative to the massage arm about one (preferably horizontal) or more swiveling axes. In particular, the joint can comprise two swiveling axes arranged crosswise.

For vibration damping, the massage element can be mounted on the massage arm via a vibration damper, e.g. a rubber connection.

Practical examples of the present invention are described in more detail below on the basis of the drawing. The drawing shows the following:

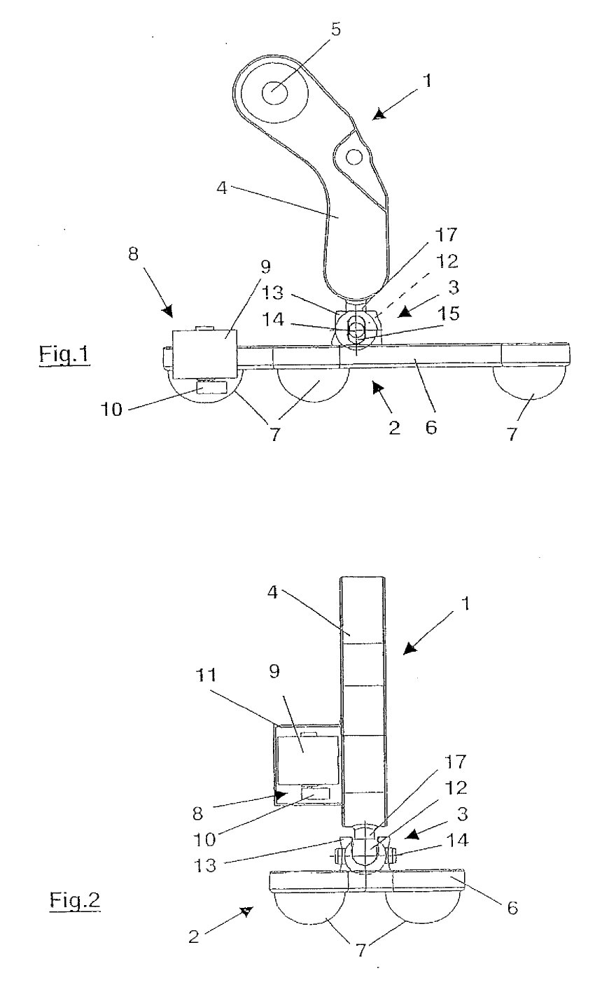

FIG. 1 A side view of a massage arm with a massage element, where a vibration device inserted in a dome-shaped massage body is exposed,

FIG. 2 A face-end view of a second practical example, showing an exposed housing for a vibration device,

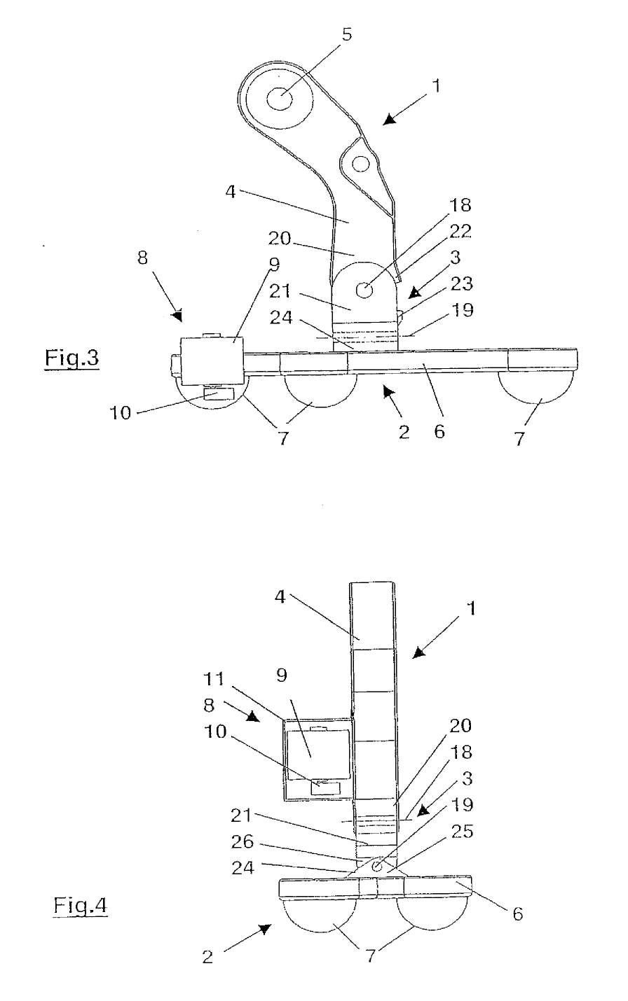

FIG. 3 A side view of a practical example according to FIG. 1, with a different articulated connection between the massage arm and the massage element, and

FIG. 4 A face-end view of a practical example according to FIG. 2, with the other articulated connection.

As can be seen from FIG. 1, a massage arm 1 is connected to a massage element 2 by a joint 3 that permits swiveling movement of massage element 2 about several axes.

The drawing shows only holding arm 4 of massage arm 1, said holding arm 4 being freely mounted in a bearing 5 on a motor-driven shaft not shown in the drawing. Mounting is performed on an eccentric end of the shaft that is arranged at an angle relative to the shaft in a direction such that both eccentric oscillation of holding arm 4 parallel to the drawing plane of FIG. 1 is generated, and also pivoting of holding arm 4 perpendicular to the drawing plane of FIG. 1.

Coupled to the middle area of holding arm 4 is a projecting arm, not shown in the drawing, which is connected in articulated fashion to a second shaft, likewise not shown in the drawing. Via the motor-driven movement of the second shaft, an oscillating movement is likewise generated in the projecting arm and, via it, in holding arm 4, said oscillating movement running essentially parallel to massage element 2, possibly with a component perpendicular to massage element 2. When superimposed on the eccentric movement of holding arm 4, this oscillating movement leads to so-called “tapping” motion, whereas pivoting of holding arm 4, essentially in the vertical plane perpendicular to the drawing plane of FIG. 1, causes so-called “kneading” motion.

The above-mentioned oscillating movement and eccentric movement lie in a frequency range up to 15 Hz, and simulate the massage effect of manual massaging by a therapist. As a result, the body surface to be treated is massaged over a large area and uniformly, the muscles involved are moved, and the meridians activated.

As can likewise be seen from the drawing, massage element 2 consists of a flat, hand-shaped supporting part 6, with massage bodies 7 located on the side opposite holding arm 4, the surface of which acts on the human body. Corresponding openings are provided in supporting part 6 to accommodate dome-shaped massage bodies 7. A vibration device 8 extends through one of the openings into dome-shaped massage body 7, and is rigidly fixed to supporting part 6.

As indicated in FIG. 1, vibration device 8 consists of an electric motor 9, the drive shaft of which is provided with an unbalance 10. Rotation of unbalance 10 generates a vibrating movement in the frequency range between 15 and 100 Hz, which is superimposed on the oscillating and eccentric movement of holding arm 4, which brings about the tapping and kneading movement of massage element 2. This results in an ideal combination of relatively slow kneading and tapping with cramp-relieving vibration.

In the practical example illustrated in FIG. 2, the vibration device is rigidly connected to holding arm 4 in the vicinity of joint 3.

Vibration device 8 is located in a housing 11, which is fastened laterally to holding arm 4 in the vicinity of joint 3. In this instance, vibration device 8 again consists of an electric motor 9, on the drive shaft of which an unbalance 10 is mounted. The vibration generated on the end of holding arm 4 pointing towards massage element 2 is transmitted to massage element 2 via joint 3.

As can be seen from FIGS. 1 and 2, joint 3, which connects massage arm 1 to massage element 2, consists of a ball-and-socket joint with a ball head 12, located on holding arm 4, and a ball socket 13, located on the side of supporting part 6 opposite massage bodies 7. Ball head 12 displays two opposite pins 14, which extend perpendicular to massage arm 1 and engage opposite openings 15 in ball socket 13. Pins 14 and openings 15 prevent rotation of massage element 2 about the axis running in the longitudinal direction of holding arm 4.

Openings 15 are of elongated design in the longitudinal direction of holding arm 4, such that the pivoting angle of the articulated connection between massage arm 1 and massage element 2 in the vertical plane perpendicular to the drawing plane of FIG. 2 is restricted to a predetermined range. This prevents rotation of massage element 2 in this plane, and also in the drawing plane of FIG. 1.

As can be seen particularly from FIG. 2, ball socket 13 is provided with a U-shaped groove 16 that is open towards the edge of ball socket 13 and into which a cylindrical extension 17 of ball head 12 can be pivoted. Groove 16 is located in the plane of massage arm 1 parallel to the drawing plane of FIG. 1 and perpendicular to the drawing plane of FIG. 2, such that massage arm 1 can be folded in relative to massage element 2 in this plane.

The connection between ball head 12 and holding arm 4 can display a rubber mount or another vibration damper, in order to largely prevent transmission of the vibration to the holding and drive device for the massage element.

The practical example illustrated in FIG. 3 differs from that shown in FIG. 1 in that joint 3 comprises two axes 18 and 19 arranged crosswise. This articulated connection is also to be seen in the practical example illustrated in FIG. 4, which otherwise corresponds to the practical example according to FIG. 2.

The articulated connection forming axis 18 displays a hinge element 20 on the end of holding arm 4 of massage arm 1 pointing towards massage element 2, as well as a fork-shaped hinge element 21, which is connected to massage element 2 via the articulated joint forming axis 19. On the side of holding arm 4, to the middle area of which the projecting arm not shown in the drawing can be coupled, hinge element 20 is provided with a projection 22, which interacts with a stop 23 on hinge element 21 in order to limit the pivoting angle of massage element 2 in the counterclockwise direction relative to holding arm 4. In the other, clockwise pivoting direction, massage element 2 can be pivoted without restriction until it comes into contact with holding arm 4.

The pivoting connection about axis 19 is formed by the above-mentioned hinge element 21 and a hinge element 24 mounted on supporting part 6 of massage element 2. Hinge element 24 displays two limbs 25, which extend perpendicular to axis 19 and whose sides are inclined. A narrower area 26 of hinge element 21 is located between these limbs 25. Narrower area 26 is set off from the remaining hinge element 21, the width of which roughly corresponds to the distance between the outer sides of limbs 25, by a shoulder that runs perpendicular to the longitudinal axis of holding arm 4 and is located above limbs 25 with slight clearance. The inclined side surfaces of limbs 25 thus serve as stop faces for the shoulder, and limit the pivoting angle of massage element 2 in both directions during pivoting about axis 19.

In the practical example shown in FIG. 4, vibration device 8 is, as in the practical example according to FIG. 2, mounted in a housing 11 at the end of holding arm 4 that points towards massage element 2. The design of vibration device 8 corresponds to that described above in connection with FIG. 2.

### LIST OF REFERENCE NUMBERS

1 Massage arm
2 Massage element
3 Joint
4 Holding arm
5 Bearing
6 Supporting part
7 Massage body
8 Vibration device
9 Electric motor
10 Unbalance
11 Housing
12 Ball head
13 Ball socket
14 Pin
15 Opening
16 Groove
17 Extension
18 Axis
19 Axis
20 Hinge element
21 Hinge element
22 Projection
23 Stop
24 Hinge element
25 Limb
26 Narrower area

1. Massage arm (1) with a massage element (2) for a massage unit that can be mounted in a massage chair or another item of furniture used for sitting or lying, where a first and a second shaft are comprised, where the massage arm (1) displays a holding arm (4), connected in articulated fashion to a first shaft, on the free end of which the massage element (2) is located in articulated fashion, and a projecting arm, connectable in articulated fashion to a second shaft, one end of which acts on the holding arm (4), where the shafts can be moved in the massage unit by means of a drive in order to produce a first vibrating movement in a first frequency range, and where the massage element (2) displays at least one contact surface acting on the body of the person to be massaged, characterized in that a vibration device (8) is located on the massage element (2) or the holding arm (4) for generating a second vibrating movement, superimposed on the first vibrating movement, in a second frequency range that is higher than the first.

2. Massage arm (1) according to claim 1, characterized in that the second frequency range is between 15 and 100 Hz.

3. Massage arm (1) according to claim 2, characterized in that the second frequency range is between 20 and 70 Hz.

4. Massage arm (1) according to claim 2, characterized in that the second frequency range is between 20 and 40 Hz.

5. Massage arm (1) according to claim 1, characterized in that the vibration device (8) is located in the vicinity of the contact surface of the massage element (2).

6. Massage arm (1) according to claim 5, where the massage element (2) displays at least one massage body (7) with a contact surface acting on the body of the person to be massaged characterized in that the vibration device (8) is located next to the massage body (7).

7. Massage arm (1) according to claim 5, where the massage element (2) displays at least one massage body (7) with a contact surface acting on the body of the person to be massaged, characterized in that the vibration device (8) is inserted in the massage body (7).

8. (canceled)

9. (canceled)

10. Massage arm (1) according to claim 1, characterized in that the vibration device (8) displays an electric motor (9), the drive shaft of which is provided with an unbalance (10).

11. Massage arm (1) according to claim 1, characterized in that the articulated connection between the massage arm (1) and the massage element (2) displays a ball-and-socket joint.

12. Massage arm (1) according to claim 1, characterized in that the articulated connection between the massage arm (1) and the massage element (2) comprises pivoting axes (18, 19) arranged crosswise.
